(19) United States
(12) Patent Application Publication
(10) Pub. No.: US 2007/0012134 A1
(43) Pub. Date: Jan. 18, 2007

(54) Defect-compensating gear assembly for a timepiece mechanism

(75) Inventor: Jerome Daout, Rolle (CH)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ROLEX S.A., Geneve (CH)

(21) Appl. No.: 11/482,756

(22) Filed: Jul. 10, 2006

(30) Foreign Application Priority Data
Jul. 15, 2005 (EP) 05405440.8

(51) Int. Cl. F16H 55/18

(52) U.S. Cl. 74/440

(57) ABSTRACT

In this defect-compensating gear assembly for a timepiece mechanism, in which at least some of the uniformly distributed teeth of at least one of the mating toothed moving parts have regions which are elastically deformable in the direction of their respective thicknesses, the meshing teeth of said moving parts have at least two simultaneous contact points, the addition of the nominal thicknesses (e_{SJ}, e₂) of the teeth in contact of said respective mating moving parts, measured along the pitch circles (C₁, C₂) of these mating moving parts, gives a resultant length greater than the pitch (p) of these toothed moving parts. The thickness of said elastically deformable region extends on either side of the theoretical profile of said teeth.

The present invention relates to a defect-compensating gear assembly for a timepiece mechanism, in which at least some of the uniformly distributed teeth of at least one of the mating toothed moving parts have regions which are elastically deformable in the direction of their respective thicknesses, the meshing teeth of said moving parts having at least two simultaneous contact points.

A number of backlash-compensating gear assemblies of the aforementioned type have already been proposed for various types of mechanisms. This is particularly the case with JP 63 130961 A, U.S. Pat. No. 4,127,041 and EP 1 380 772.

Gear assemblies most often have some backlash to make allowance for all the tolerances which necessarily affect the engagement conditions; otherwise, it would be possible to choose a backlash-free tooth profile, as confirmed by “Théorie Générale de l'Horlogerie” [General Theory of Horology], L. Defossez, 1950, first volume, p. 210, published by Chambre Suisse de l'Horlogerie [Swiss Chamber of Horology], La Chaux-de-Fonds (Switzerland). The backlash is the difference between the pitch and the sum of the widths of two respective teeth of the two wheels; the backlash is a length generally expressed as a function of the pitch. The backlash, the pitch and the width of the teeth to which reference will be made in the description which follows are all expressed as lengths measured along the pitch diameter of the toothed moving parts. The pitch diameter of a toothed wheel is the diameter of the pitch circle of this wheel which is tangential to the pitch circle of the wheel with which it engages, and the pitch is the distance measured along the pitch circle between two homologous points of two consecutive teeth (L. Defossez, cited on p. 149). Finally, the theoretical profile of the tooth is the profile of a backlash-free tooth of a gear assembly in which the moving parts would have perfect teeth, would be perfectly concentric and would have perfect center-to-center distances, without any play in the bearings, etc.

All of the aforementioned prior art documents essentially broach the problem of the elasticity to be given to the teeth, but virtually ignore the problem of the dimensioning of the teeth.

EP 1 380 772 indicates as a condition that the teeth of the wheel and the teeth of the pinion have the same thickness e and the same gap width. The reason why this condition of equality is necessary according to this document in order to achieve a backlash-free gear assembly is not explained. However, it is possible to state that if such a gear assembly with teeth having the same thickness and the same gap width constitutes a particular case of a backlash-free gear assembly, this is true only in the case of the ideal theoretical conditions being met. This therefore represents a theoretical solution. In fact, the stated conditions do not make it possible to eliminate the backlash when the center-to-center distance of the moving parts is greater than the required value, in the event of roundness distortion or too small a diameter in particular.

With regard to JP 63 130961 A, it merely states that the thickness of the teeth must be determined to eliminate the backlash. One may well suspect that the reason for any backlash is because the thickness of the teeth is too narrow. It has been seen above why the thickness of the teeth is narrower than the thickness of the theoretical profile. Just stating that the thickness of the teeth must be determined to eliminate the backlash says absolutely nothing about how to achieve this objective. It should therefore be pointed out that up until now not a single document provides any indication relating to a rule allowing the engagement backlash to be substantially compensated for while making allowance for all the defects and influences liable to create this backlash and without thereby taking the risk of the gear assembly jamming under the pretext of eliminating the backlash thereof. It should indeed not be forgotten that the essential task of a gear assembly is to transmit a torque with the best possible efficiency and that the elimination of the backlash must be compatible with this function.

JP 59 117951 A has further proposed a gear assembly for a speed reduction mechanism in which the backlash is eliminated by using two toothed wheels side by side which have the same toothings and which are rigidly secured to one another to form a single toothed wheel. One of the toothed wheels is made of a rigid material and the other of an abrasion-resistant elastic material. The wheel which is made of rigid material is intended to transmit a torque and an angular position and the other is intended to eliminate the backlash through the elastic deformation of its teeth. The teeth of the wheel made of elastic material have a greater thickness than the teeth of the wheel made of rigid material, so as to be deformed when they are in mesh with the teeth of the mating wheel.

Such a solution is quite simply unacceptable in the case of a timepiece mechanism, more particularly a wristwatch mechanism, for many reasons. Such a solution entails, in particular, a doubling of the size of the gear assemblies, both that of the compensating wheel and that of the mating wheel. Now the question of size is an essential factor in a wristwatch mechanism.

Next comes the problem of the rigid connection between the two side-by-side wheels, which presents problems of alignment precision, which, on account of the very small dimensions of the teeth, of a few tenths of a millimeter in the case of a wristwatch mechanism, necessarily introduces an additional margin of error. Such an assembly also involves an extra extremely tricky operation.

The presence of two materials creates tension problems owing to the differences in the coefficients of expansion.

Such a solution also adversely affects the efficiency of the transmission of torque by the gear assembly because of the higher coefficient of friction between, for example, an elastomer used as the material of the toothed wheel with deformable teeth and the steel of a mating pinion, and also because of the low hardness of this material and of the soft contact which increases the contact areas and therefore the friction. Now the efficiency of the torque transmitted from the barrel containing the drive spring to the escapement of the regulating system constitutes an important factor for the quality of the watch.

In a timepiece gear train, there are high pressures on the teeth owing to the torques to be transmitted, with the result that the presence of a deformable material increases the contact areas and therefore the wear. With a wheel made of plastic material, the efficiency would also be a function of the temperature on account of the high coefficient of expansion of such a material. A similar situation applies in the case of humidity, which causes plastic materials to expand. Given that a quality timepiece mechanism should have a service life of several tens of years, a plastic material does not make it possible to satisfy this requirement. Such a material would also cause degassing problems, would create electrostatic charges and would cause washing bath resistance problems.

The object of the present invention is to overcome, at least partially, the aforementioned disadvantages.

To this end, the subject of the invention is a defect-compensating gear assembly for a precision mechanism, particularly a timepiece mechanism, as claimed in claim 1.

The main advantage of the defect-compensating gear assembly forming the subject of the present invention is to define the conditions for the dimensioning of the backlash-compensating teeth, these conditions making allowance for all disruptive elements and making it possible in all cases to obtain at least substantial, if not complete, backlash compensation even in the extreme conditions admitted by the prescribed tolerances, which was clearly not the case with the solutions proposed up until now.

The appended drawings illustrate, schematically and by way of example, the problem to be solved and various embodiments of defect-compensating gear assemblies capable, even in the extreme cases, of providing an at least partial solution to this problem.

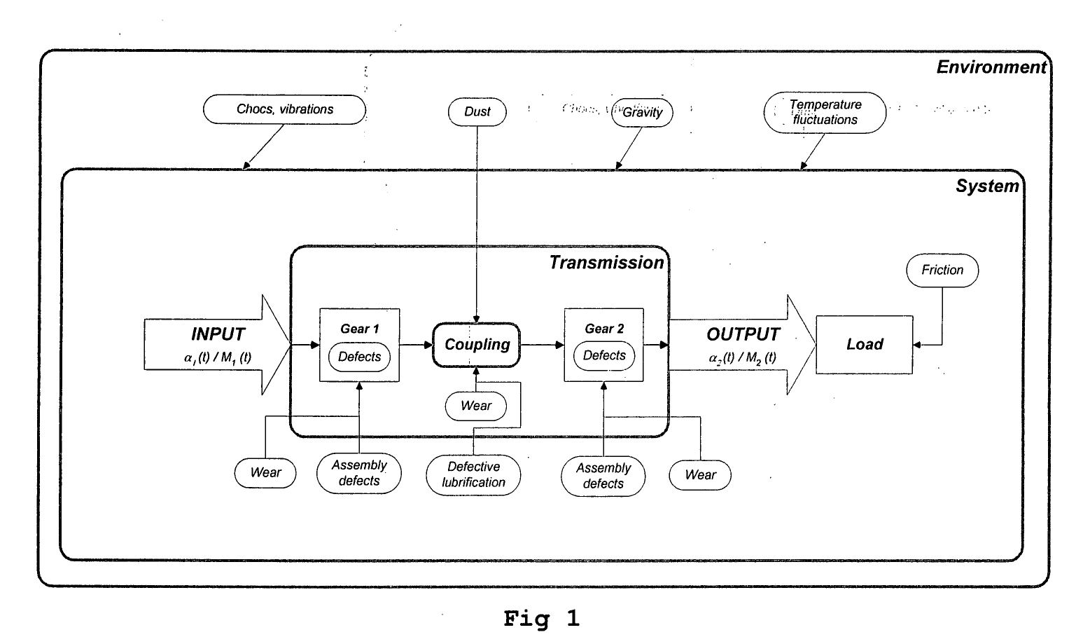

FIG. 1 is a functional diagram indicating the influential parameters and the defects of a gear assembly;

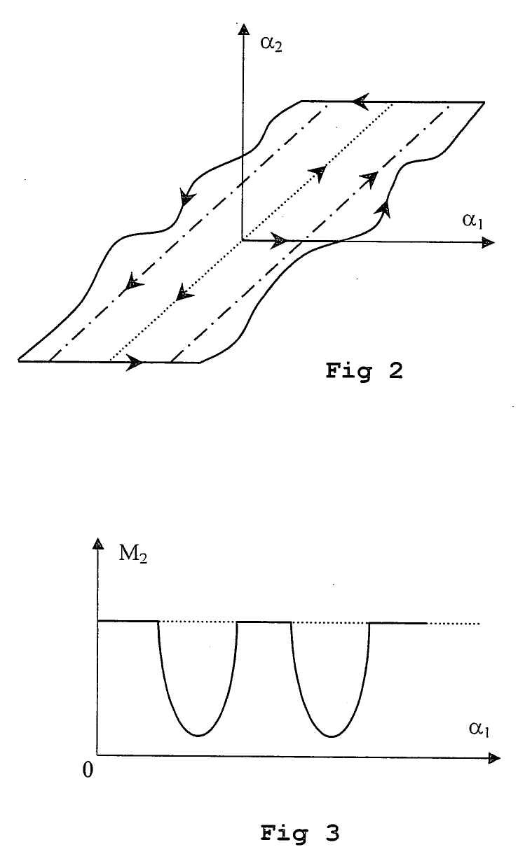

FIG. 2 is a diagram of the transmission between two toothed wheels without compensation;

FIG. 3 is a diagram of the torque transmitted when there is clamping between the teeth;

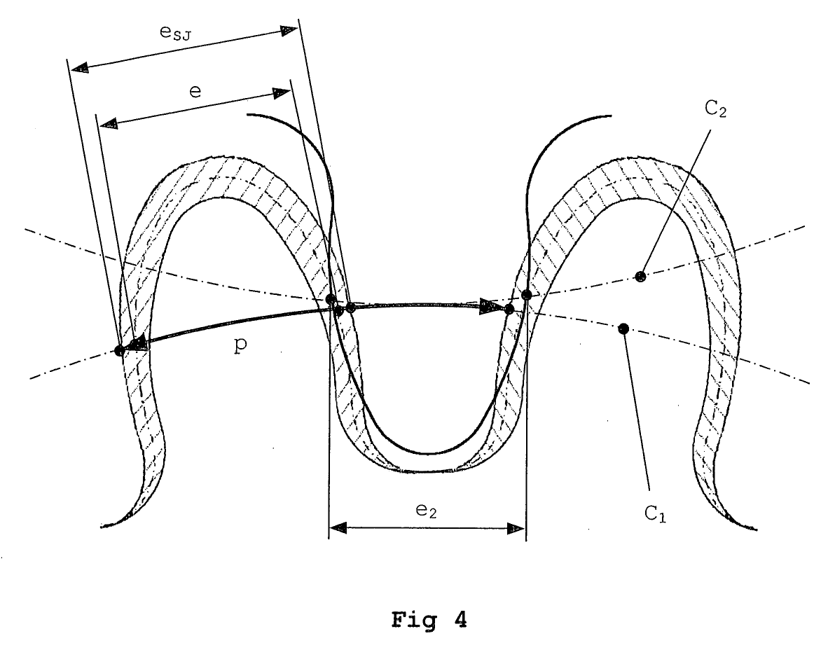

FIG. 4 is a part view of a defect-compensating gear assembly configuration intended to explain the dimensioning model for this gear assembly;

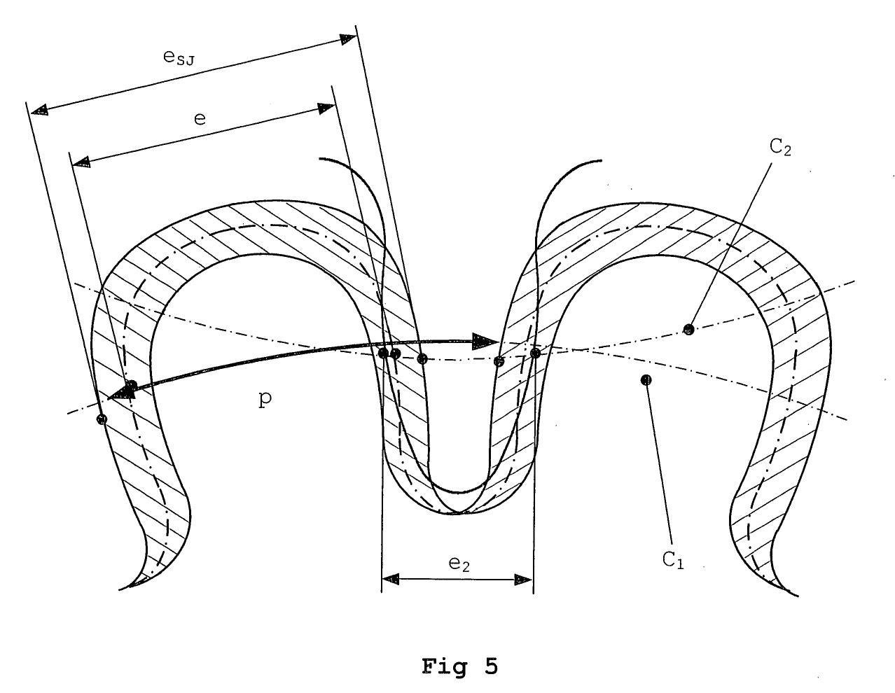

FIG. 5 is a similar view of FIG. 4 intended to define the thickness limits of the compensating teeth;

FIG. 6 is a part view of a normal gear assembly with too small a center-to-center distance;

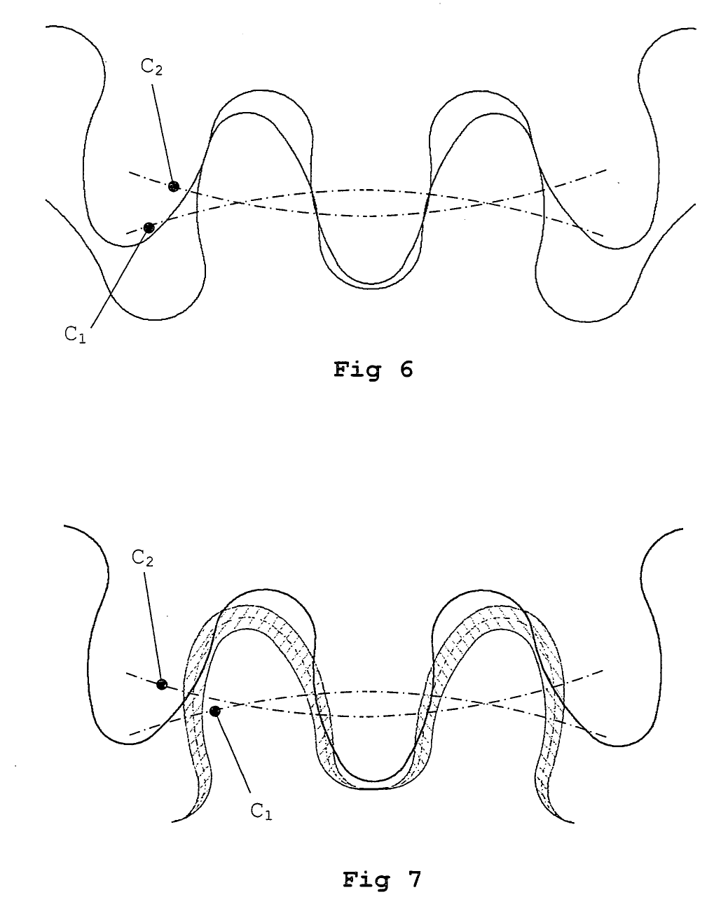

FIG. 7 is a part view of a gear assembly for compensating the defect shown in FIG. 6;

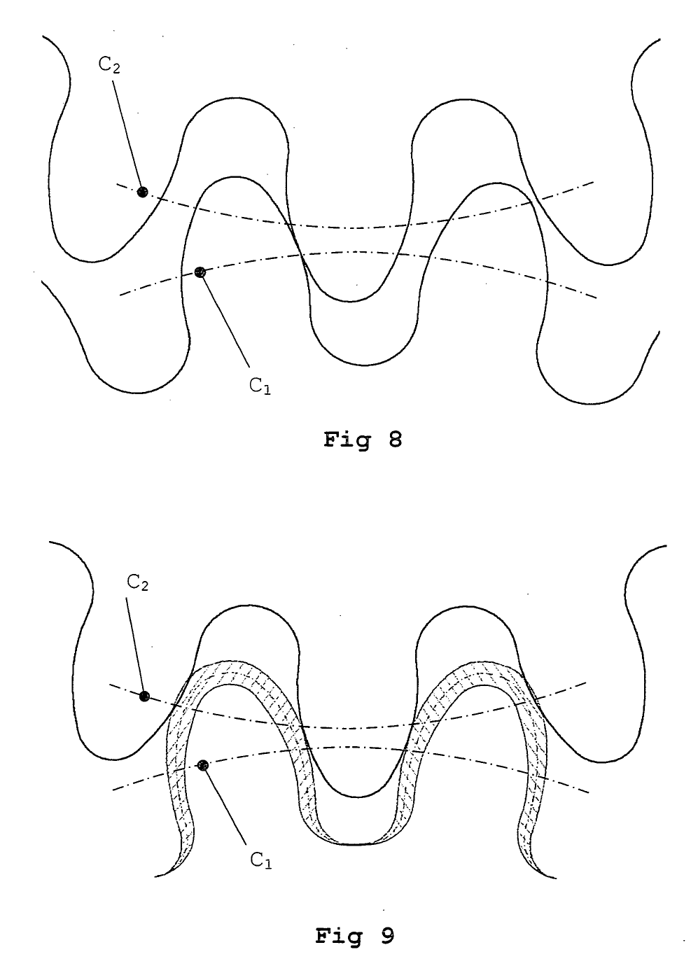

FIG. 8 is a part view of a normal gear assembly with too large a center-to-center distance;

FIG. 9 is a part view of the compensating gear assembly of FIG. 7, showing that it makes it possible to compensate for the defects shown in FIGS. 6 and 8;

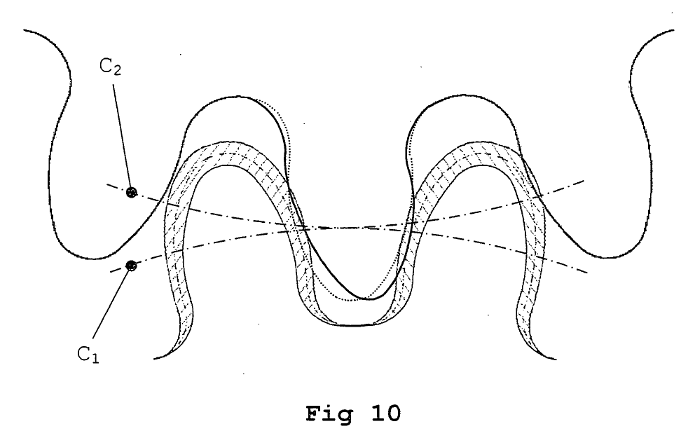

FIG. 10 is a part view of a defect-compensating gear assembly with a wheel having compensating teeth in mesh with a wheel having normal teeth in which one tooth is deformed;

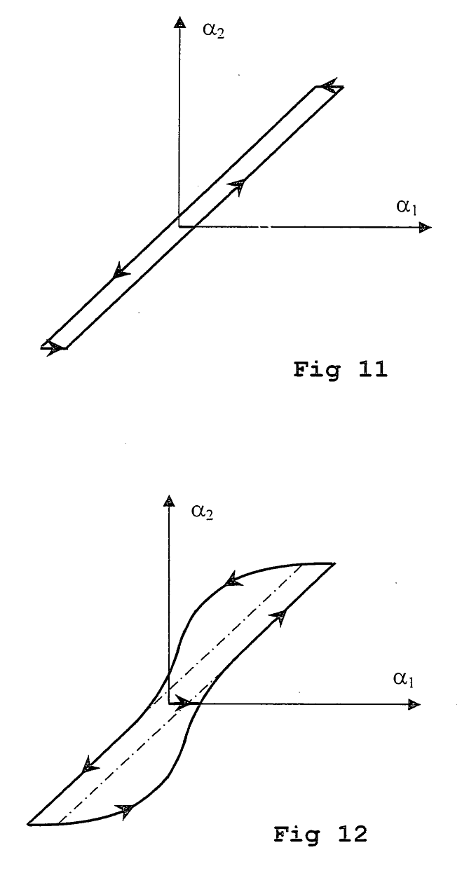

FIGS. 11 and 12 are two diagrams showing the transmission of movement between two toothed wheels of a compensating gear assembly.

The diagram of FIG. 1 illustrates the various parameters which influence the transmission of the angular displacement as a function of time α₁(t), of the angular velocity as a function of time ω₁(t) and of the torque as a function of time M₁(t) in a gear assembly. These influences originate from the system itself and comprise the defects of the toothed wheels, including those of their toothing. Defects which may be mentioned in particular are roundness distortion, off-centering, inclination of the axes, variations in the penetration of the toothings due to variations in the center-to-center spacing, play of the pivots in the bearings, wear, a buckled tooth and lubricant aging. These influences also originate from external factors such as shocks and vibrations, dust, gravity and temperature variations.

If account is taken of the sum of all the potential defects within the admitted tolerances, the angular displacement α₁ of the driving moving part with respect to the angular displacement α₂ of the driven moving part can be represented in a system of coordinates like that illustrated in FIG. 2. In an ideal gear assembly, the transmission would be represented by the inclined dotted line passing through the origin of the coordinates α₁, α₂ in the two directions of rotation of these wheels. In the case of a conventional gear assembly with backlash between the toothings, but without any defect, the transmission in the two directions of rotation would be parallel to the dotted line but given the backlash we would have a horizontal line during a change in the direction of rotation, the angular displacement α₁ then not causing any angular displacement α₂. Consequently, the resulting diagram would be a parallelogram, as illustrated in dot-and-dash lines.

In reality, neither of the two situations illustrated by the respective dotted-line and dot-and-dash line diagrams in FIG. 2 exists, both relating to theoretical cases. In reality, in the case of backlash in the toothing of the gear assembly, we would have a diagram in which the various aforementioned defects would substantially modify the shape of the parallelogram, as illustrated by the continuous line in FIG. 2.

In the case of clamping, the backlash no longer exists; by contrast, this defect is manifested by a reduction in the transmitted torque, as illustrated by the diagram of FIG. 3 in which it is possible to observe a considerable reduction in the torque M₂ transmitted on each pass of a tooth.

FIG. 4 illustrates the general dimensioning principle which must be satisfied in order to achieve at least partial compensation in all cases, making allowance not only for all the defects which the gear unit may have within the tolerances, over the whole range of these tolerances, but also for any future defects, particularly those associated with wear.

In this figure, the hatched portion of the toothing corresponds to the elastically deformable portion, the remainder corresponding to the rigid portion. The dot-and-dash line situated in the hatch portion corresponds to the theoretical profile of the tooth, the width e of which corresponds to half a pitch p of the toothing, assuming that the tooth width of the mating moving part is also equal to half a pitch. One condition for there to be compensation of the backlash in the gear assembly is that the meshing teeth of the mating moving parts have at least two simultaneous contact points. To satisfy this condition in all cases, and to obtain at least partial compensation of the defects, it is required that the elastically deformable portion extends on either side of the theoretical profile of the compensating tooth, with the result that the thickness of this compensating tooth e_{SJ} is then greater than half a pitch p. Another condition for this compensation to occur in all cases is that, by adding the thickness e_{SJ} of the compensating tooth and the thickness e₂ of the tooth of the mating moving part, the resultant length is greater than the pitch p measured along one of the pitch circles C₁ or C₂ of one of the moving parts of the gear assembly. When mention is made of the thickness e_{SJ} of the compensating tooth, this refers to its nominal thickness and not to its thickness after deformation.

It has been stated above that one of the conditions for allowing at least partial compensation of all the defects of a precision gear assembly, particularly of a gear assembly for a timepiece, within admitted tolerances, is that the sum of the thickness e_{SJ} of a tooth with a compensating elastic portion and of the thickness e₂ of a normal tooth of the mating wheel must be greater than the pitch p of this gear assembly. We will now examine the range within which the part of this sum which is greater than the pitch p is situated.

As can be observed, it is entirely possible to satisfy the aforementioned conditions by substantially increasing the thickness e_{SJ} of the compensating teeth and reducing the thickness e₂ of the normal teeth of the mating moving part, as illustrated, for example, in FIG. 5. This solution which allows the thickness of the compensating teeth to be increased has the advantage of providing greater facility for producing the elastic portion of the compensating teeth, something which may be advantageous especially in the case of a gear assembly for a timepiece, in particular a wristwatch, mechanism in which the thickness e of the teeth is only a few tenths of a millimeter. As illustrated in this FIG. 5, the hatched portion representing the elastic compensating element of the tooth can be dimensioned until the addition of its thickness e_{SJ} and the thickness e₂ of the mating moving part reaches the value of one and a half times that of the pitch of the gear assembly.

In practice, the preferable range is:
e_{SJ}+e₂=1.05 to 1.25 p

The best conditions for obtaining the best compromise as a function of the admitted tolerances are probably situated toward 1.15 p, it being possible for this value to vary substantially as a function of the admitted tolerances.

FIGS. 6 and 8 illustrate two extreme examples, one (FIG. 6) corresponding to a gear assembly in which the center-to-center distance of the two mating moving parts is too small, as shown by the respective pitch circles C₁ and C₂ of these moving parts, the other (FIG. 8) corresponding to the inverse defect. In the first case, there is clamping, or even jamming, of the toothings of the two mating moving parts; in the other case, there is a considerable backlash.

FIGS. 7 and 9 show that in both of these cases, these two extreme defects are compensated for by one and the same compensating moving part, by virtue of the dimensioning forming the subject of the present invention. Specifically, the fact that the elastic portion represented by the hatched zone is situated on either side of the theoretical profile, which is illustrated by the dot-and-dash line in the hatched region, makes it possible, in the case of FIG. 7, to prevent clamping, whereas in the case of FIG. 9, the fact that the thickness e_{SJ} of one of the compensating teeth plus the thickness e₂ of one of the teeth of the mating moving part is greater than the pitch p makes it possible to eliminate the backlash.

It is evident that the transmission will not be identical in both cases. Specifically, in the case of the compensation example illustrated in FIG. 7, the transmission in quasi-static or dynamic mode corresponds to the diagram of FIG. 11. By contrast, in the case of FIG. 9, in quasi-static mode the transmission of movement corresponds to the diagram of FIG. 11, but in dynamic mode it corresponds to the diagram of FIG. 12, which shows that when the movement is reversed, first of all there is deformation of the elastic portion and then, when the acceleration has been absorbed by the elastic deformation portion, a return to the conditions of the quasi-static mode.

FIG. 10 illustrates another particularly unwelcome, although somewhat accidental, defect: that of a deformed tooth. A dotted line has been used to represent the normal profile of the mating tooth and a continuous line has been used to represent its actual profile. It can be observed that the hatched elastic portion of the compensating tooth makes it possible to absorb this defect and substantially attenuate the effects thereof.

It would be possible to illustrate other types of defects for which the same compensation effects would be observed. It is also possible to imagine extreme cases, for example a case in which the wheel would have roundness distortion, where the axis would be off-centered and where there would be too large a center-to-center spacing. It might not be possible to form a sufficiently thick elastic compensating portion to compensate for the sum of these defects. A problem might also arise relating to the limit of elastic deformation of the elastic compensating portion.

In that case, it is possible to envision setting a limit for the compensation by deformation of the elastic compensating portion, beyond which limit it is the rigid portion of the tooth which takes over the transmission. The elastic constant of the compensating portion may also have two increasing successive values corresponding to the elastic deformation of a first compensating element which, after having been exposed to a certain deformation, bears against a second elastic element, with the result that their two elastic constants combine. Finally, in the event of deformation beyond a certain limit, one of the elastic elements comes into butting contact with the rigid portion of the compensating tooth. Starting from this limiting degree of deformation, the gear assembly behaves in the manner of an ordinary gear assembly.

As regards the distribution between compensating and noncompensating teeth, a number of combinations are possible. It is possible in particular for all the teeth of one wheel of the gear assembly to be compensating teeth according to the invention. It is also possible for all the teeth of both wheels of the gear assembly to be compensating teeth. It is additionally possible for one in two teeth of one wheel or else one in two teeth of both wheels to be a compensating tooth. Finally, it is possible to envision one in three teeth of both wheels to be a compensating tooth, but with care being taken to ensure that they are engaged in such a way that one compensating tooth of one wheel comes between two noncompensating teeth of the other wheel.

The compensating portions situated on either side of a tooth must not necessarily have the same elastic constant. This is because it is possible, depending on the direction of rotation of the gear assembly, to have different resistive torques, so that, in order to increase the efficiency in one direction of rotation, it is possible to form asymmetric compensating teeth with flexible portions having different elastic properties on the two sides of these teeth.

1. A defect-compensating gear assembly for a timepiece mechanism, in which at least some of the uniformly distributed teeth of at least one of the mating toothed moving parts have regions which are elastically deformable in the direction of their respective thicknesses, the meshing teeth of said moving parts having at least two simultaneous contact points, wherein the addition of the nominal thicknesses (e_{SJ}, e₂) of two teeth in contact of said respective mating moving parts, measured along the pitch circles (C₁, C₂) of these mating moving parts, gives a resultant dimension greater than the pitch (p) of these toothed moving parts, and wherein the thickness of said elastically deformable region extends on either side of the theoretical profile of said teeth.

2. The gear assembly as claimed in claim 1, in which said addition of the nominal thicknesses (e_{SJ}, e₂) of said teeth is between >p and 1.5 p.

3. The gear assembly as claimed in claim 1, in which said addition of the nominal thicknesses (e_{SJ}, e₂) of said teeth is between 1.05 p and 1.25 p.
